(19) United States
(12) Patent Application Publication
(10) Pub. No.: US 2012/0113628 A1
(43) Pub. Date: May 10, 2012

(54) Light Emitting Diode Retrofit Conversion Kit for a Fluorescent Light Fixture

(75) Inventors: Grahame K. Burrow, Perrysburg, OH (US); Tarner Houser, Sylvania, OH (US)

(73) Assignee: SMASHRAY, LTD., Sylvania, OH (US)

(21) Appl. No.: 13/383,917

(22) PCT Filed: Jul. 12, 2010
(86) PCT No.: PCT/US10/41682

§ 371 Date: Jan. 13, 2012

Related U.S. Application Data
(60) Provisional application No. 61/224,939, filed on Jul. 13, 2009.

(51) Int. Cl. F21L 4/02; F21K 2/00

(52) U.S. Cl. 362/184

(57) ABSTRACT

A light emitting diode retrofit conversion kit adapted for use in a fluorescent light fixture comprises a housing adapted to be secured to a troffer; a power supply carried by the housing; and a plurality of light emitting diodes carried by the housing.

### BACKGROUND OF THE INVENTION

This invention relates in general to fluorescent lighting fixtures and in particular to an improved light emitting diode retrofit conversion kit adapted for use in such a fluorescent light fixture.

Fluorescent light fixtures come in many different sizes and shapes. Usually, the fluorescent light fixture includes one, two, three, four, six or more fluorescent light'tubes or lamps. Typically, the fixture includes a channel member which enshrouds the ballast for powering the light fixture. One problem associated with fluorescent light tubes it that since they contain mercury (a toxic substance), the tubes must be disposed of properly. Other problems associated with fluorescent light fixtures are that they have a relatively short life expectancy for the tubes and ballasts and therefore require routine maintenance. Also, the tubes can flicker, there can be a “hum” or “buzz” during operation, and the tubes can even shatter. In view of these problems and others, it is known to replace or retrofit the fluorescent tubes in a fluorescent light fixture with a tube containing light emitting diodes (LED's). The benefits of the LED lights are energy savings, longer life expectancy, no routine maintenance, minimal degradation of light color temperature and lumens over time, and the LED lights do not contain any mercury or lead.

### SUMMARY OF THE INVENTION

This invention relates to an improved light emitting diode (LED) retrofit conversion kit adapted for use in a fluorescent light fixture.

In one embodiment, the LED retrofit conversion kit comprises a housing adapted to be secured to a troffer; a power supply carried by the housing; and a plurality of light emitting diodes carried by the housing.

In another embodiment, the LED retrofit conversion kit comprises: a housing formed as an extrusion and adapted to be secured to a troffer, the housing including at least one integrally formed channel and a plurality of cooling fins formed integrally therewith on one or more surfaces thereof; a power supply carried by the housing; and a plurality of light emitting diodes carried by the housing; wherein the light emitting diodes are disposed in the channel

In yet a further embodiment, the LED retrofit conversion kit comprises: a housing formed as an extrusion and adapted to be secured to a troffer by at least one of a snap fit attachment method and a plurality of screws, the housing includes a pair of upper mounting flanges, at least a first pair of side walls, and a bottom wall; a power supply carried by the housing; and a plurality of light emitting diodes carried by the housing; wherein the light emitting diodes are disposed in the channel.

According to features of the invention, the housing is preferably formed as an extrusion, the housing preferably includes a plurality of cooling fins formed integrally therewith on one or more surfaces thereof, the housing preferably includes at least one integrally formed channel and the light emitting diodes are linked together and disposed in the channel, the channel can include threaded openings for receiving screws for securing the light emitting diode link to the channel, and the housing preferably includes an upstanding formed channel having a threaded portion for receiving a screw or other suitable fastener type to secure the power source to the housing.

According to further features of the invention the light emitting diodes are preferably electrically connected together with the use of printed circuit board links without the use of wires and solder so as to define a light emitting diode circuit, the housing is preferably secured to the troffer by a snap fit attachment method, the housing is preferably provided with notches to assist in securing the housing to the troffer, and the housing can be secured to the troffer by a plurality of screws if necessary.

Various additional aspects and other advantages of this invention will become apparent to those skilled in the art from the following detailed description of the preferred embodiments of the invention, when read in light of the accompanying drawings.

### BRIEF DESCRIPTION OF THE DRAWINGS

FIG. 1 is a perspective view of an embodiment of a light emitting diode retrofit conversion kit adapted for use in a fluorescent light fixture in accordance with this invention.

FIG. 2 is a perspective view of the light emitting diode retrofit conversion kit shown in FIG. 1.

FIG. 3 is another perspective view of the light emitting diode retrofit conversion kit, showing only the housing portion thereof.

FIG. 4 is a bottom plan view of the light emitting diode retrofit conversion kit.

FIGS. 4A and 4B are perspective views of a portion of the light emitting diode retrofit conversion kit.

FIG. 5 is a side plan view of the light emitting diode retrofit conversion kit.

FIG. 6 is a top plan view of the light emitting diode retrofit conversion kit.

FIG. 7 is a top plan view of the light emitting diode retrofit conversion kit similar to FIG. 6 but only showing the housing portion thereof.

FIG. 8 is a enlarged view of a portion of the light emitting diode retrofit conversion kit taken from FIG. 4.

FIG. 9 is a enlarged view of a portion of the light emitting diode retrofit conversion kit taken from FIG. 4.

FIG. 10 is a view of the light emitting diode retrofit conversion kit taken along line 10-10 of FIG. 1.

FIG. 10A is a view similar in part to FIG. 10 but showing an alternate embodiment of the light emitting diode retrofit conversion kit in accordance with this invention.

FIG. 11 is an enlarged view of a portion of the light emitting diode retrofit conversion kit, showing the housing.

FIG. 12 is an enlarged view of a portion of the light emitting diode retrofit conversion kit taken from FIG. 10.

FIG. 13 is a view of a portion of a prior art fluorescent light fixture.

### DETAILED DESCRIPTION OF THE PREFERRED EMBODIMENTS

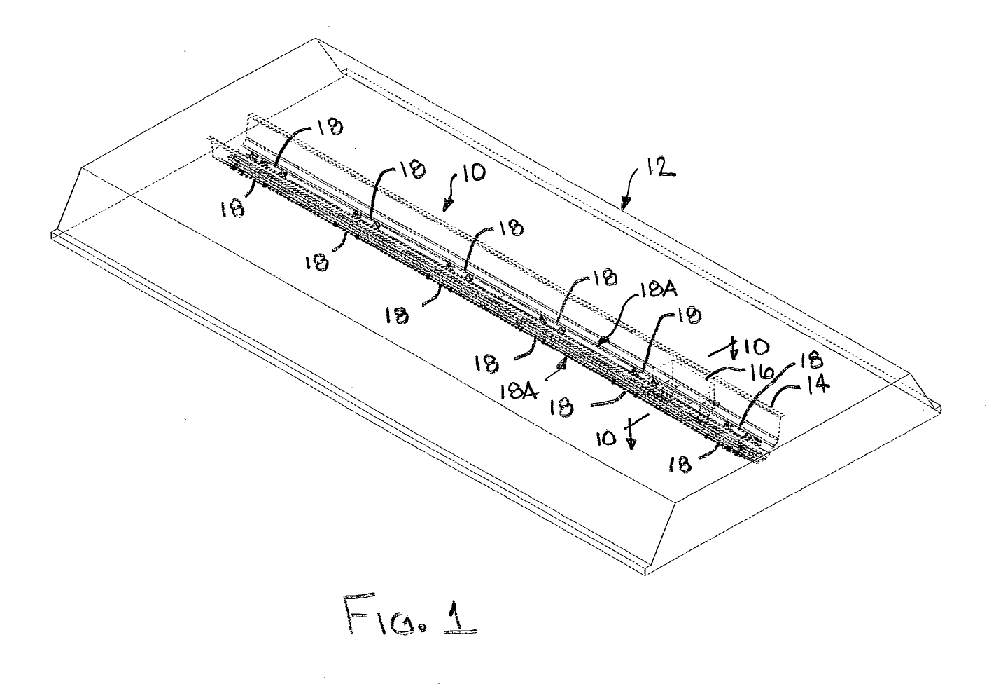

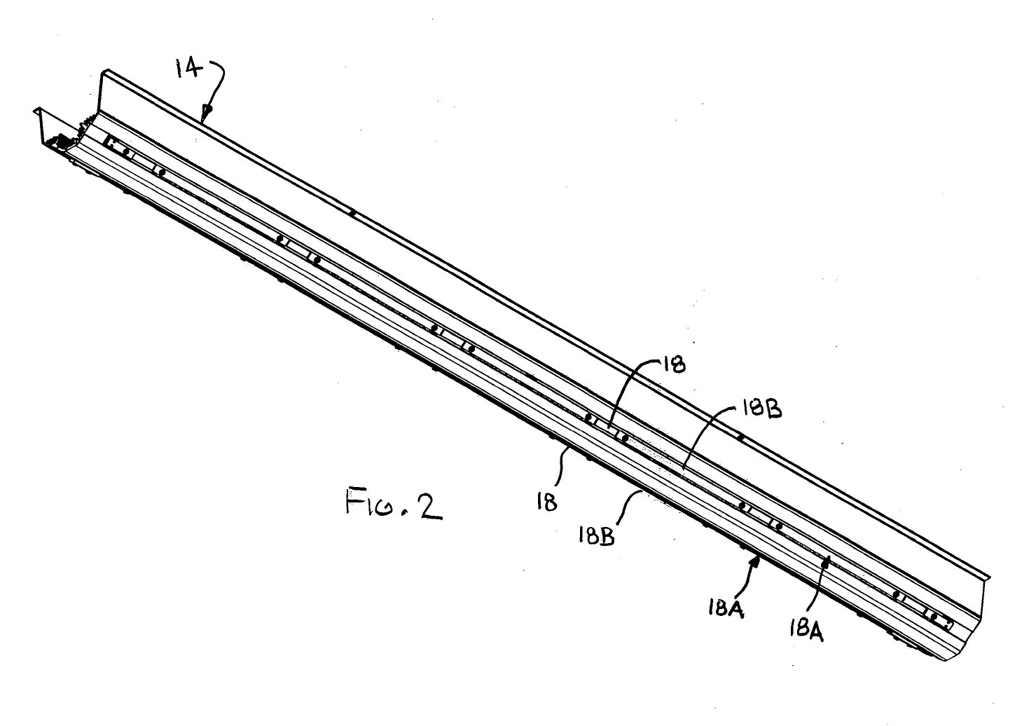

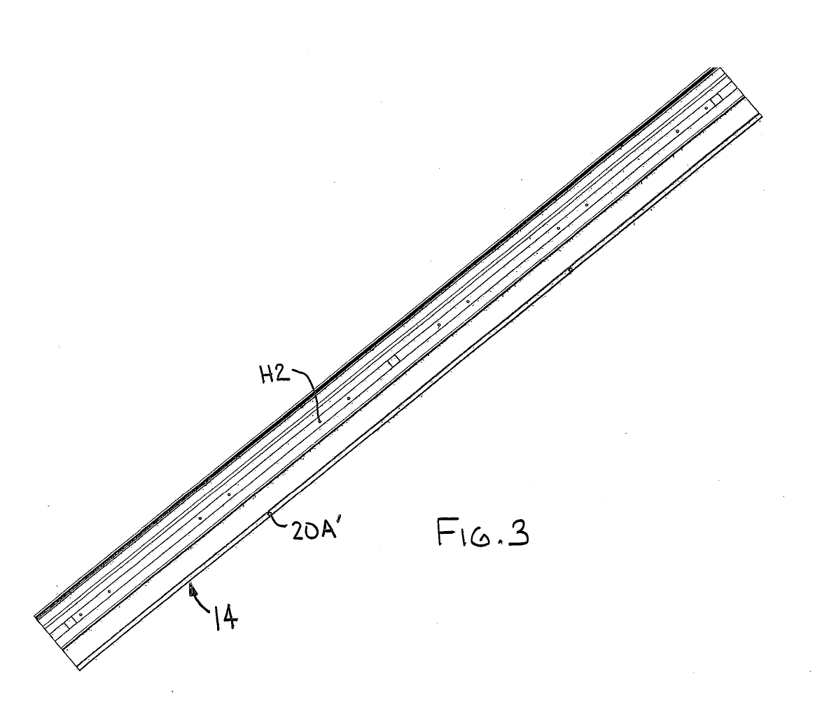

Referring now to FIG. 1, there is illustrated a perspective view of an embodiment of a light emitting diode (LED) retrofit conversion kit, indicated generally at 10, adapted for use in a fluorescent light fixture, indicated generally at 12. The illustrated LED retrofit conversion kit 10 is shown as being installed in a commonly used two foot by four foot fluorescent light fixture 12 which includes two, three, four, six or more four foot long fluorescent tubes (not shown). Although the present invention will be described and illustrated in connection with the particular fluorescent light fixture or fixtures disclosed herein, it will be appreciated that the invention may be used in any other suitable lighting fixture structure or product if so desired. For example, the LED retrofit conversion kit 10 may be used to retrofit any existing size and/or type of fluorescent light fixture, may also be used as a new installation, and may be of any desired length, if so desired.

In the illustrated embodiment, the LED retrofit conversion kit 10 includes a main body or housing 14, a power supply 16, and a plurality of LED's 18 operatively coupled'to the power supply 16 by suitable means. The housing 14 can be formed from any suitable material, such as for example aluminum. In the illustrated embodiment, the housing 14 is preferably formed as an extrusion; however, the housing 14 may be formed from other materials and/or by other methods if so desired.

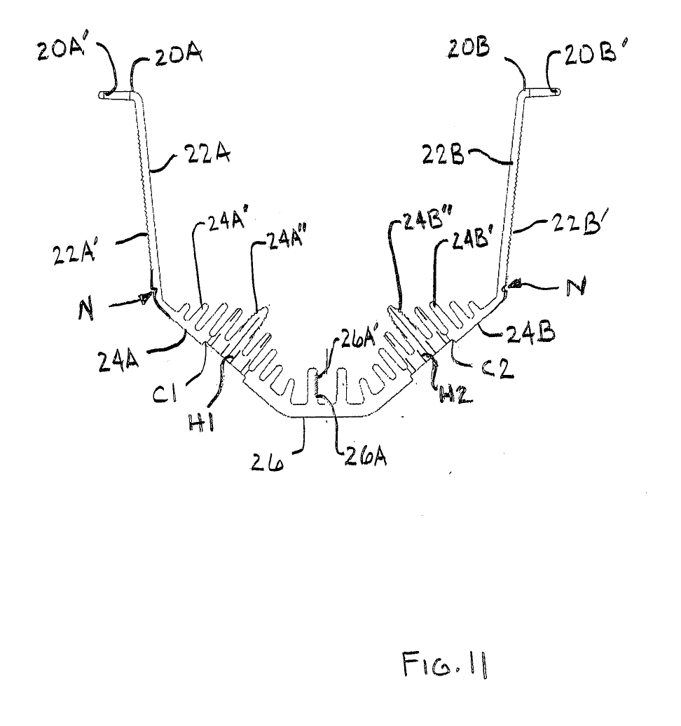

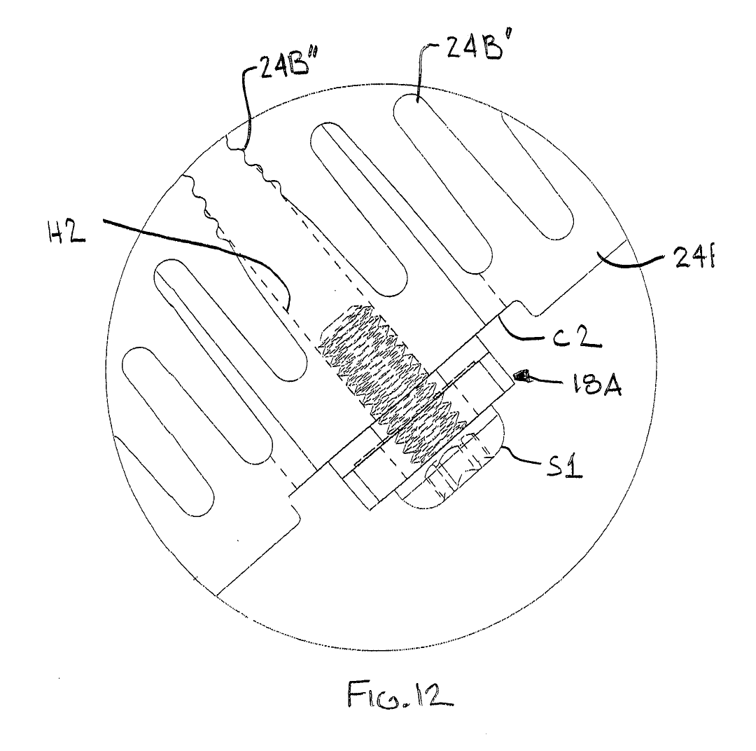

In the illustrated embodiment, the housing 14 is generally U-shaped and, as best shown in FIGS. 10 and 11, includes a pair of “upper short” walls or “mounting flanges” 20A and 20B, a first pair of angled side walls 22A and 22B, a second pair of angled side walls 24A and 24B, and a “lower” or bottom wall 26. The mounting flanges 20A and 20B may be provided with a plurality of “mounting” holes 20A′ and 20B, respectively, formed therein, for a purpose to be discussed below. In the illustrated embodiment, each of the mounting flanges 20A and 20B is provided with two of such mounting holes 20A′ and 20B′, respectively. Alternatively, the construction and/or configuration of one or both of the mounting flanges 20A and 20B of the housing 14 may be other than illustrated if so desired.

In the illustrated embodiment, the first pair of side walls 22A and 22B are preferably provided with a plurality of “cooling” fins or ribs 22A′ and 22B, respectively, on at least a portion of at least one surface thereof. In the illustrated embodiment, the fins 22A′ and 22B′ are relatively “short” or “small” and are provided along substantially an entire portion of an outer surface of the side walls 22A and 22B, respectively, thereof. Alternatively, the construction and/or configuration of one or both of the side walls 22A and 22B of the housing 14 may be other than illustrated if so desired. For example, the side walls 22A and 22B may be straight (i.e., generally perpendicular to the mounting flanges 20A and 20B, respectively), if so desired. Also, the side walls 22A and 22B of the housing 14 may include cooling fins (not shown but which may be similar to or different from the fins 22A′ and 22B′), in place of or in addition to the fins 22A′ and 22B′, respectively, which are provided along at least a portion of an inner surface thereof, if so desired.

In the illustrated embodiment, the second pair of side walls 24A and 24B are preferably provided with a plurality of “upstanding cooling” fins or ribs 24A′ and 24B, respectively, provided on at least a portion of one surface thereof. In the illustrated embodiment, the fins 24A′ and 24B′ are provided along substantially an entire portion of an inner surface of the side walls 24A and 24B, respectively, thereof. As can be seen in the illustrated embodiment, all of the fins 24A′ and 24B′ are not identical to one another but rather the fins 24A′ and 24B′ are arranged in a tiered or peak like manner. In the illustrated embodiment, each of the side walls 24A and 24B is provided with nine of such fins 24A′ and 24B′, respectively. Also, in the illustrated embodiment, one or more of the fins 24A′ and 24B′ are preferably provided with a plurality of “small” cooling fins or ribs 24A″ and 24B″ along selected portions of an outer surfaces thereof

Also, in the illustrated embodiment each of the side walls 24A and 24B preferably includes an integral channel C1 and C2, respectively, provided along a portion of an outer surface thereof for a purpose to be discussed below. Additionally, a plurality of threaded holes H1 and H2 are preferably provided along the channels C1 and C2, respectively, of the side walls 24A and 24B at predetermined locations for a purpose to be discussed below. Alternatively, the construction and/or configuration of one or both of the side walls 24A and 24B of the housing 14 may be other than illustrated if so desired. For example, the side walls 24A and 24B of the housing 14 may include cooling fins (not shown but which may be similar to or different from the fins 24A′ and 24B′), in place of or in addition to the fins 24A′ and 24B′, respectively, which are provided along at least a portion of an outer surface thereof, if so desired. Also, the side walls 24A and 24B of the housing 14 do not have to include the integral channels C1 and C2, if so desired.

In the illustrated embodiment, the bottom wall 26 is preferably provided with an integrally formed “extruded upstanding” channel or slot 26A formed therein. Preferably, as shown in the illustrated embodiment, the channel 26A includes at least a portion or portions thereof which include threads 26A′ for a purpose to be discussed below. Alternatively, the construction and/or configuration of the bottom wall 26 of the housing 14 may be other than illustrated if so desired. For example, the bottom wall 26 of the housing 14 may include cooling fins (not shown), which are provided along at least a portion of one or both of an inner surface and an outer surface thereof, if so desired. Also, none of the walls 22A, 22B, 24A, 24B and 26 may include cooling fins if so desired. Further, the overall construction and/or configuration of the housing 14 may be other than illustrated if so desired. As described above and illustrated the housing 14 has a generally U-shape; however the housing 14 may be generally channel-shaped, square-shaped, rectangular-shaped, V-shaped or of any other suitable shape and/or configuration if so desired.

In the illustrated embodiment, the power source 16 is carried by the housing 14. To accomplish this, one or more screws S (or any other suitable fastener type or method), as shown in FIG. 10, preferably extends through an opening provided in a mounting flange 16A of the power source 16 and are threadably received in the threads 26A′ of the channel 26A of the bottom wall 26 of the housing 14 to thereby secure the power source 16 to the housing 14. Also, any other associated components, such as for example, a power source grounding lug (not shown), may also be secured to the housing 14 in a similar manner if so desired. Alternatively, the securing of the power source 16 to the housing 14, and the securing of any other associated components, may be other than illustrated if so desired.

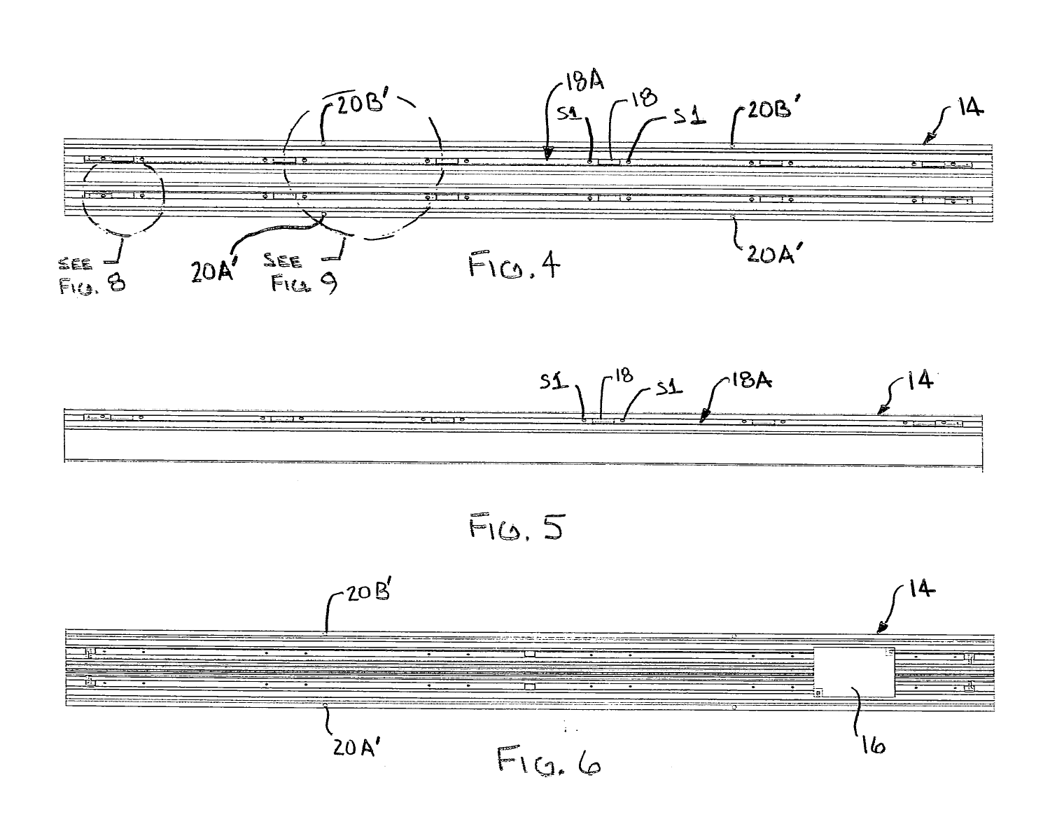

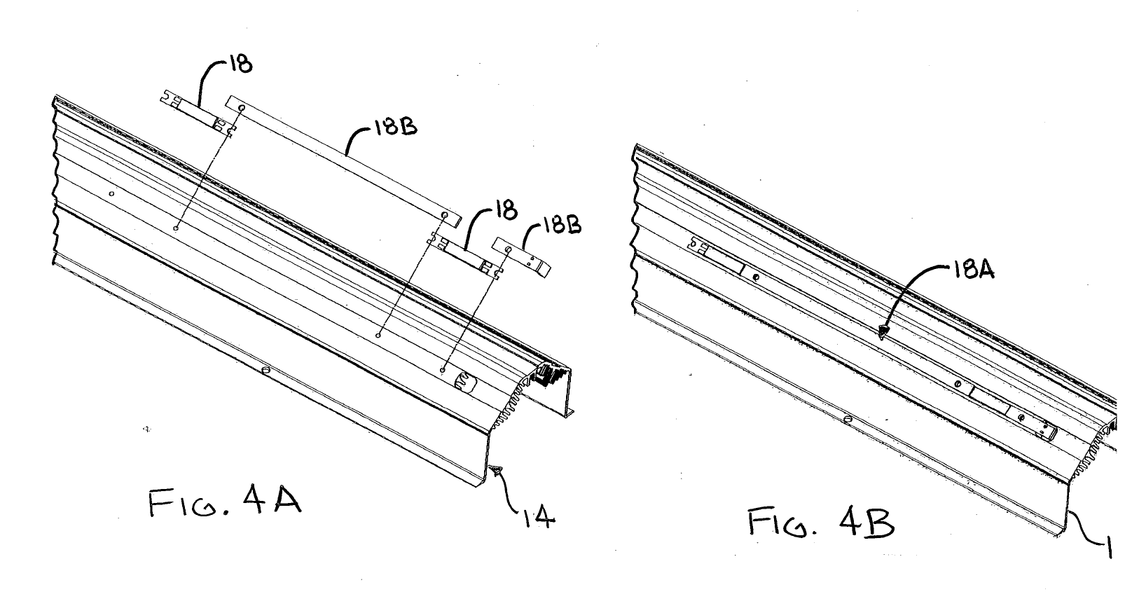

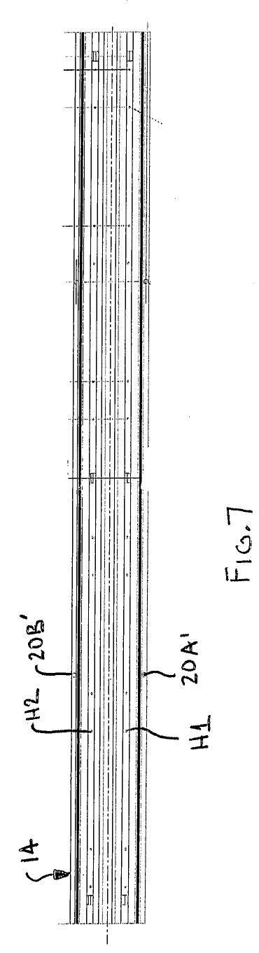

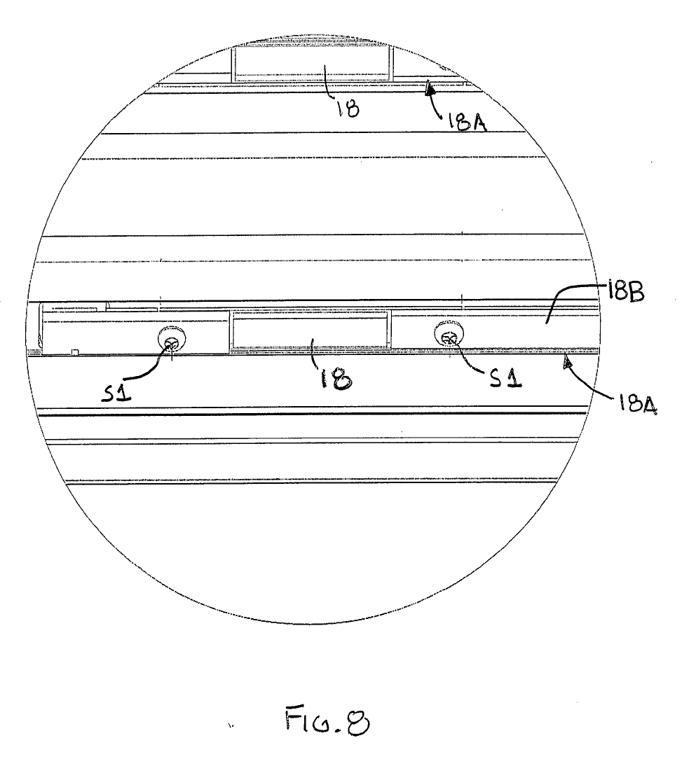

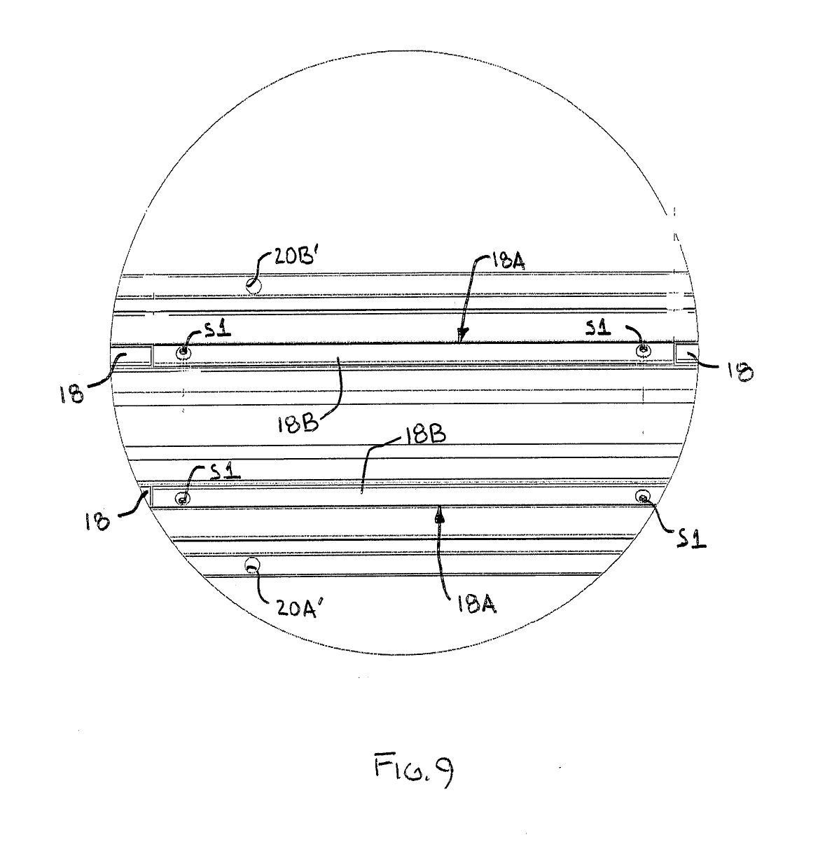

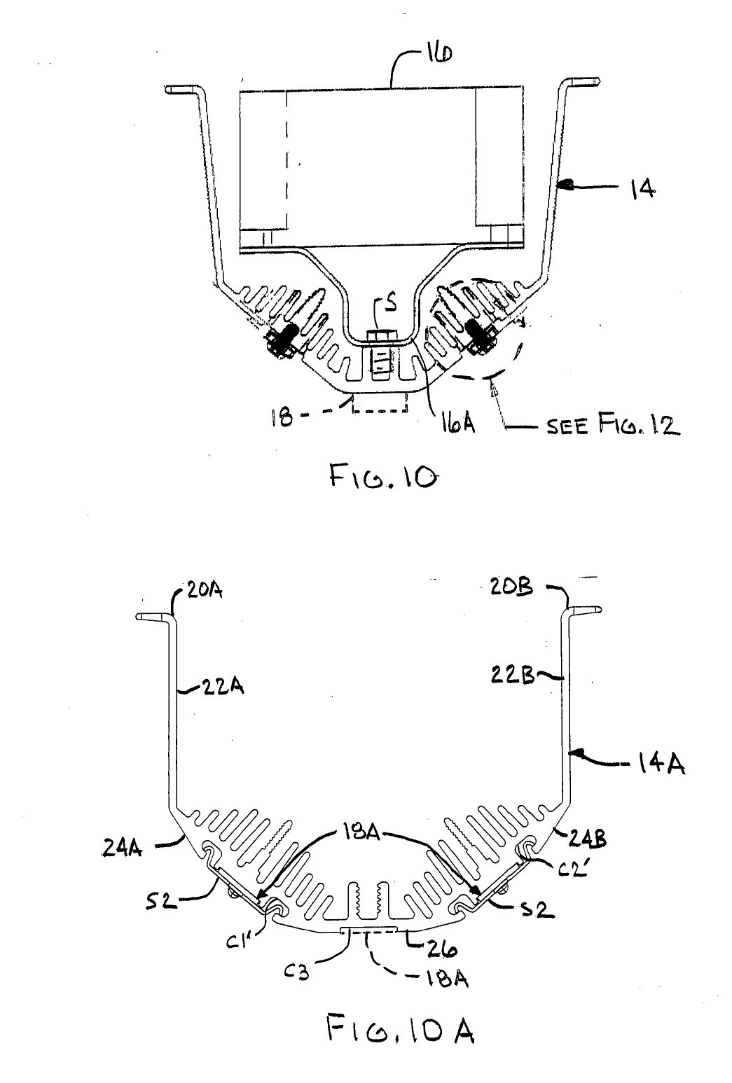

In the illustrated embodiment, the LED's 18 are preferably electrically connected together with the use of printed circuit board links 18B (best shown in FIGS. 4A and 4B), without the use of wires and solder so as to define a LED circuit, indicated generally at 18A. Preferably, each LED circuit 18A consists of at least two or more LED's 18 operatively connected together by a printed circuit board link system, such as for example, designed with TouchPad Electronics, which are manufactured by TouchPad Electronics of Wisconsin, USA. The use of this design allows the LED's 18 to provide a path for the current which allows the LED's 18 to be connected together in series so as to form a multiple LED circuit 18A having any desired number of LED's 18 operatively connected together. Alternatively, the construction, configuration and/or lay out of the LED's 18 may be other than illustrated and described if so desired.

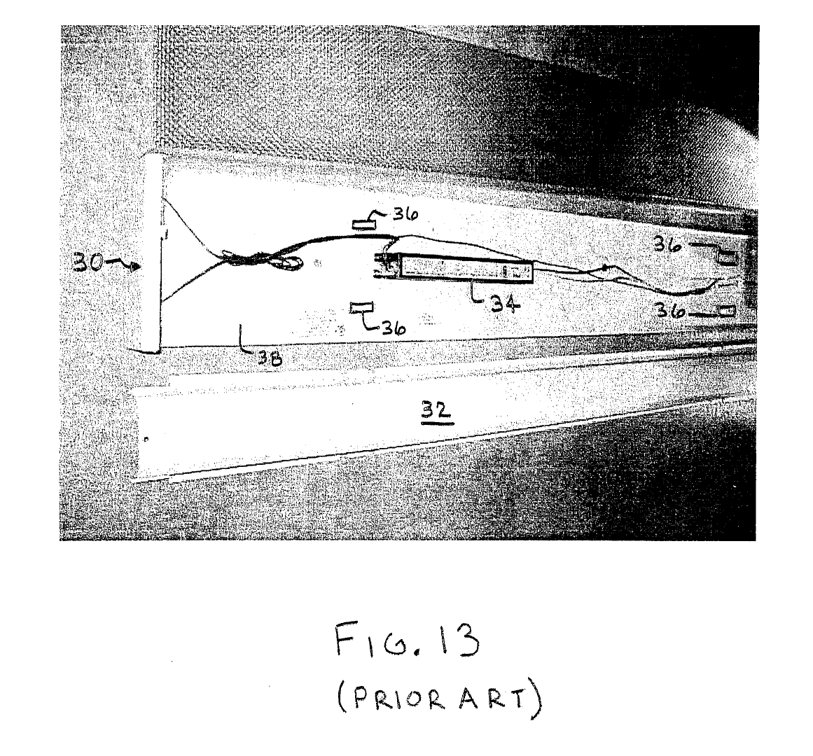

In the illustrated embodiment, the LED circuits 18A are disposed in the channels C1 and C2 provided in the side walls 24A and 24B of the housing 14. Suitable fastening means, such as a screw S1 (best shown in FIG. 12), are disposed through holes provided in the LED circuits 18A and secured in the threaded holes H1 and H2 provided in channels C1 and C2, respectively, to secure the LED circuits 18A to the housing 14.

Alternatively, the construction of the LED's 18, the printed circuit board links 18B, the LED circuits 18A, and/or the securing of the LED's 18, the printed circuit board links 18B and/or the LED circuits 18A to the housing 14 may be other than illustrated if so described. For example, as shown in phantom in FIG. 10, one or more LED's 18 (or the LED circuit 18A), may be secured by appropriate means “directly” to the bottom wall 26 of the housing 14, i.e., the bottom wall 26 not being provided with an integral channel like the channels C1 and C1 of the side walls 24A and 24B, respectively. Thus, it will be appreciated that any one or more of the associated walls of the housing 14 may have any desired number, configuration and/or orientation of one or more LED's 18, printed circuit board links 18B, and/or LED circuits 18A secured thereto either in an integral channel formed therein and/or directly thereto (i.e., no integral channel).

Also, other suitable fastening or securing methods may be used, such as for example, spring clips, adhesives, snaps, clamps and the like. For example as shown in FIG. 10A and using like reference numbers to indicate corresponding parts, spring clips S2 may be secured in channels C1′ and C2′ provided in a housing 14A to secure the LED circuits 18A therein. In this embodiment, the spring clips S2 eliminate the need for the threaded holes H1 and H2 in the housing 14 as shown in the embodiment of FIG. 10. Also, as shown in the embodiment of FIG. 10A, the bottom wall 26 may include an integral channel C3 formed therein which is used for securing an LED circuit 18A (shown in phantom or one or more LED's 18 (not shown)) therein by suitable means.

One advantage of the present invention is that the LED retrofit conversion kit 10 is designed for a relatively simple retrofit into existing fluorescent fixtures and troffers, such as shown for example in prior art FIG. 13 and indicated generally at 30. The retrofit will normally require the existing prior art ballast cover shroud 32 to be removed, along with the prior art ballast(s) 34, the prior art tubes (not shown) and the prior art tube sockets (not shown). Then, under typical circumstances, the housing 14 of the LED retrofit conversion kit 10 will conveniently replace the existing ballast shroud and use the same mounting method to attach the housing 14 to the troffer. The attachment method can “snap” the housing 14 into place using the existing snap tabs 36 located along the mounting surface 38 of most fluorescent troffers 30. This is accomplished by grasping the housing 14 in a lengthwise fashion and “squeezing” it so the flanges 12A and 12B compress or move inwardly. This allows the housing 14 to fit between the snap tabs 36 that are integral to the fluorescent troffer 30. Once the compression is released the housing 14 is then firmly held in place. In addition, to aid in this type of attachment method, the housing 14 may include one or more “flex notches”, indicated generally at N in FIG. 11, formed into the part profile. In the illustrated embodiment, the notches N extend into a portion of the housing 14 preferably along the length of the side walls 22A and 22B and effective to create a “weaker” point along the housing 14 so squeezing of the housing 14 into place is simplified and ergonomic. In existing designs where snap tabs do not exist, the housing 14 can be installed by using the preformed holes 20A′ and 20B′ as a template to drill corresponding mounting holes in the existing troffer and then fasten the housing 14 in place using suitable fastening means, such as self tapping sheet metal screws.

Another advantage of the present invention is that if the housing 14 is preferably formed as an extrusion, though not required, the housing 14 can be cut to any length which makes it applicable to virtually any size pre-existing fixture (i.e., length of two feet, four feet, eight feet, etc.). Another advantage of the present invention is that the LED retrofit conversion kit 10 is a single fixture requirement. What this means specifically is only one LED retrofit conversion kit 10 is needed to replace multiple fluorescent tubes. Another advantage of the present invention is that the design of the profile of the housing 14 thereof is such that the power supply 16 is mounted under the housing 14 in an open channel that is appropriately sized. Thus, the power supply 16 will be self contained and hidden from a person's view when installed in the troffer fixture.

Still further possible advantages of the present invention are that the aluminum housing 14 profile provides the following features: 1) provides thermal management (heat sink) properties that are necessary to allow the mounted LED's 18 to operate efficiently by extracting and dissipating the heat generated when operating. This is achieved through the associated cooling fins that are extruded into the housing across the selected desired surfaces thereof. The associated fins can be easily modified, added or removed in the extrusion tool as needed to optimize thermal properties and ultimately LED life. Virtually any surface of the housing 14 can be provided with such associated fins; 2) the integral channels that are designed into the lengthwise surface of the housing 14 facilitate precise locating of LED's 18 when installed; 3) the design of the housing 14 can easily be adapted to add additional channels along any desired surface (i.e., side, top, etc), which would enable more LED's and/or rows of LED circuits 18A to be installed. The illustrated channel design accommodates “linear” (rectangular shape) style LED's, such as the Edison Opto “ediline” series and various Cecol (Citizen) brand models. However, the housing 14 with the channel or without the channel can accommodate any desired LED style, such as CREE brand; 4) the LED's sit in the channels formed in the housing 14 at a specific angle for light output. As a result, the design can be can be easily modified to accommodate any required angle; and 5) additional “port” or vent holes can be added along any desired surface of the housing 14 to permit better “cooling” air circulation around the housing 14 for improved thermal management and heat dissipation.

Also, while the LED retrofit conversion kit 10 of the present invention is described and illustrated for use in preferably for the retro-fitting of existing fluorescent fixtures, the LED retrofit conversion kit 10 may also be used as a new fixture in new installations. Another advantage of the present invention is that the preferred method of connecting the LED's together electrically without the use of wires and solder but by forming the illustrated and described above links provides a path for current which allows LED's to be connected in series. These links are then affixed to the housing and at the same time each end section of links apply compression to the links and compress the LED's into place without the need for separate attachment schemes for the LED's proper.

Still a further advantage of the present invention is that the extruded slot 26A on the underside of the housing 14 is provided with threads 26A′. This allows a mounting screw(s) S to be installed on the bottom side to hold the power supply 16 and grounding lug in place without having to drill and thread mounting holes. Additionally, other components (i.e., harness clips, nameplates, etc.), could be fastened in a similar manner. Further, the housing 14 may be anodized in any desired color, including but not limited to, clear, black, blue, purple, copper, and red. Still further the light output of the LED retrofit conversion kit 10 of the present invention may be affected by the diffuser lens installed in the existing fluorescent troffer fixture. New lenses and diffusers may be designed to enhance or modify the output characteristics of the light of the present invention. Also, dimming features may be added to the LED retrofit conversion kit 10 of the present invention if so desired to allow user control of the light output. Furthermore, light harvesting features may be added to the LED retrofit conversion kit 10 of the present invention to allow user control of the light output. In addition, the LED retrofit conversion kit 10 of the present invention allows for refurbishment of the light if failures occur or the customer returns the product to the manufacturer after the end of product life. This is a cost effective way to re-use some components and minimize disposal in the waste stream.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A light emitting diode retrofit conversion kit adapted for use in a fluorescent light fixture comprising:
a housing adapted to be secured to a troffer;
a power supply carried by the housing; and
a plurality of light emitting diodes carried by the housing.

2. The light emitting diode retrofit conversion kit of claim 1 wherein the housing is formed as an extrusion.

3. The light emitting diode retrofit conversion kit of claim 1 wherein the housing includes a plurality of cooling fins formed integrally therewith on one or more surfaces thereof.

4. The light emitting diode retrofit conversion kit of claim 1 wherein the housing includes at least one integrally formed channel and the plurality of light emitting diodes are disposed in the channel

5. The light emitting diode retrofit conversion kit of claim 4 wherein the channel includes threaded openings for receiving screws for securing the plurality of light emitting diodes to the channel.

6. The light emitting diode retrofit conversion kit of claim 1 wherein the housing includes an upstanding formed channel having a threaded portion for receiving a screw to secure the power supply to the housing.

7. The light emitting diode retrofit conversion kit of claim 1 wherein at least two of the plurality of light emitting diodes are electrically connected together with the use of printed circuit board links so as to define a light emitting diode circuit.

8. The light emitting diode retrofit conversion kit of claim 1 wherein the housing is secured to the fluorescent light fixture by a snap fit attachment method.

9. The light emitting diode retrofit conversion kit of claim 8 wherein the housing is provided with notches to assist in securing the housing to the troffer.

10. The light emitting diode retrofit conversion kit of claim 1 wherein the housing is secured to the fluorescent light fixture by a plurality of screws.

11. The light emitting diode retrofit conversion kit of claim 1 wherein the housing includes a pair of upper mounting flanges, at least a first pair of side walls, and a bottom wall.

12. The light emitting diode retrofit conversion kit of claim 11 wherein at least a portion of one of an inner wall and an outer wall of the first pair of side walls includes a plurality of cooling fins formed integrally therewith.

13. The light emitting diode retrofit conversion kit of claim 11 further including a second pair of side walls, and wherein at least a portion, of one of an inner wall and an outer wall of at least one of the first and second pair of side walls includes a plurality of cooling fins formed integrally therewith.

14. A light emitting diode retrofit conversion kit adapted for use in a fluorescent light fixture comprising:
a housing formed as an extrusion and adapted to be secured to a troffer, the housing including at least one integrally formed channel and a plurality of cooling fins formed integrally therewith on one or more surfaces thereof;
a power supply carried by the housing; and
a plurality of light emitting diodes carried by the housing; wherein the light emitting diodes are disposed in the channel.

15. The light emitting diode retrofit conversion kit of claim 14 wherein the channel includes threaded openings for receiving screws for securing the plurality of light emitting diodes in the channel.

16. The light emitting diode retrofit conversion kit of claim 14 wherein at least two of the light emitting diodes are electrically connected together with the use of printed circuit board links so as to define a light emitting diode circuit.

17. The light emitting diode retrofit conversion kit of claim 14 wherein the housing is secured to the fluorescent light fixture by one of a snap fit attachment method and a plurality of screws.

18. The light emitting diode retrofit conversion kit of claim 14 wherein the housing includes a pair of upper mounting flanges, at least a first pair of side walls, and a bottom wall, and wherein at least a portion of one of an inner wall and an outer wall of the first pair of side walls includes a plurality of cooling fins formed integrally therewith.

19. The light emitting diode retrofit conversion kit of claim 18 further including a second pair of side walls, and wherein at least a portion of one of an inner wall and an outer wall of at least one of the first and second pair of side walls includes a plurality of cooling fins formed integrally therewith.

20. A light emitting diode retrofit conversion kit adapted for use in a fluorescent light fixture comprising:
a housing formed as an extrusion and adapted to be secured to a troffer by at least one of a snap fit attachment method and a plurality of screws, the housing includes a pair of upper mounting flanges, at least a first pair of side walls, and a bottom wall;
a power supply carried by the housing; and
a plurality of light emitting diodes carried by the housing, at least two of the light emitting diodes electrically connected together with the use of printed circuit board links so as to define a light emitting diode circuit.
